(19) United States
(12) Patent Application Publication
(10) Pub. No.: US 2015/0169123 A1
(43) Pub. Date: Jun. 18, 2015

(54) TOUCH SENSOR CONTROLLER AND METHOD FOR DRIVING THE SAME

(71) Applicant: Samsung Electronics Co., Ltd., Suwon-si (KR)

(72) Inventors: Seung-Jae LEE, Suwon-si (KR); Karimulla SHAIK, Andhra Pradesh (IN); Devendran MANI, Chennai (IN); Ramya BAGAVATH SINGH, Virudhunagar District (IN); Jong-Seon KIM, Seongnam-si (KR); Jong-Kang PARK, Hwaseong-si (KR); Hae-Yong AHN, Hwaseong-si (KR); Yoon-Kyung CHOI, Seoul (KR)

(21) Appl. No.: 14/488,365

(22) Filed: Sep. 17, 2014

(30) Foreign Application Priority Data
Dec. 12, 2013 (KR) 10-2013-0154896

(51) Int. Cl. G06F 3/041

(52) U.S. Cl. CPC G06F 3/0412; G06F 2203/04104

(57) ABSTRACT

A method for driving a touch sensor controller is provided. The method includes receiving touch data from a touch sensor panel and performing interpolation on the received touch data using characterization parameters according to a size and location of a conductor to increase a number of touch data points.

### CROSS-REFERENCE TO RELATED APPLICATION

This application claims priority under 35 U.S.C. §119 to Korean Patent Application No. 10-2013-0154896, filed on Dec. 12, 2013, the disclosure of which is incorporated by reference herein in its entirety.

### TECHNICAL FIELD

The present inventive concept relates to a touch sensor, and more particularly, to a touch sensor controller and a method for driving the touch sensor controller.

### DISCUSSION OF THE RELATED ART

A touch sensing system is capable of recognizing a touch event by sensing a capacitance level formed between transmitting (TX) and receiving (RX) electrodes on a touch sensor panel (TSP).

The TSP includes a plurality of TX and RX electrodes. Variations of capacitance levels generated between the TX and RX electrodes may be measured by a mutual capacitance sensor. For example, the mutual capacitance sensor is capable of measuring a variation in a mutual capacitance, which decreases when a conductor such as a finger or a stylus pen approaches to the TSP, in the form of two-dimensional (2D) data.

### SUMMARY

In accordance with an embodiment of the present inventive concept, a method for driving a touch sensor controller is provided. The method includes receiving touch data from a touch sensor panel and performing interpolation on the received touch data using characterization parameters according to a size and location of a conductor to increase a number of touch data points.

In an embodiment of the present inventive concept, the performing of the interpolation may include using the characterization parameters as interpolation filter coefficients.

In an embodiment of the present inventive concept, the method may further include applying a weighted average method to the increased number of touch data points.

In an embodiment of the present inventive concept, the applying of the weighted average method may include calculating coordinates corresponding to a touch input.

In an embodiment of the present inventive concept, the method may further include performing extrapolation on the touch data when a location having a maximum value of the touch data is an edge or side of the touch sensor panel.

In an embodiment of the present inventive concept, the performing of the extrapolation may include deriving virtual touch data corresponding to the outside of the touch sensor panel.

In an embodiment of the present inventive concept, the performing of the extrapolation algorithm may include using a Gaussian function.

In an embodiment of the present inventive concept, the method may further include selecting a first region of the touch sensor panel using a gradient of the touch data in the vicinity of a maximum value among the touch data and performing the interpolation on the first region.

In an embodiment of the present inventive concept, the gradient of the touch data may be calculated by comparing differential values between touch data in the vicinity of the maximum value among the touch data.

In an embodiment of the present inventive concept, the characterization parameters may include a gradient of a curve of a differential capacitance level according to the size and location of the conductor, a peak value, and a variance in a Lanzcos curve.

In accordance with an embodiment of the present inventive concept, a touch sensor controller is provided. The touch sensor controller is configured to receive touch data from a touch sensor panel and to perform interpolation on the received touch data using characterization parameters according to a size and location of a conductor to increase a number of the touch data points.

In an embodiment of the present inventive concept, the characterization parameters may be used as interpolation filter coefficients.

In an embodiment of the present inventive concept, the characterization parameters may include a gradient of a curve of a differential capacitance level according to the size and location of the conductor, a peak value, and a variance in a Lanzcos curve.

In an embodiment of the present inventive concept, the touch sensor controller may be configured to perform extrapolation on the touch data when a location having a maximum value of the touch data is an edge or side of the touch sensor panel.

In an embodiment of the present inventive concept, the touch sensor controller may be configured to select a first region of the touch sensor panel using a gradient of the touch data in the vicinity of a maximum value among the touch data and to perform the interpolation on the first region.

In an embodiment of the present inventive concept, a circuit board including the touch sensor controller may be provided. The circuit board may further include an application processor and a touch sensor panel. The application process may be configured to process multimedia data. The touch sensor panel may be configured to receive the touch data. The characterization parameters may include a gradient of a curve of a differential capacitance level according to the size and location of the conductor, a peak value, and a variance in a Lanzcos curve.

In accordance with an embodiment of the present inventive concept, a method for driving a touch sensor controller is provided. The method includes receiving touch data from a touch sensor panel when a touch is input, detecting a location having a maximum value among the received touch data, calculating gradients of differential values between touch data in the vicinity of the maximum value, and performing interpolation on a first region of the received touch data. The first region is selected based on the calculated gradients to increase a number of touch data points.

In an embodiment of the present inventive concept, the performing of the interpolation may include using characterization parameters according to a size and location of a conductor as interpolation filter coefficients.

In an embodiment of the present inventive concept, the method may further include storing the increased touch data in a sampling buffer as first touch data and extracting second touch data from the first touch data using a capacitance threshold. The second touch data may be extracted when a value of the second touch data is equal to or greater than the capacitance threshold.

In an embodiment of the present inventive concept, the method may further include calculating a touched region based on the second touch data and extracting coordinates of the touch input by applying a Centroid method to values corresponding to the calculated touched region.

### BRIEF DESCRIPTION OF THE DRAWINGS

The foregoing and other features of the present inventive concept will be more apparent by describing in detailed exemplary embodiments thereof with reference to the accompanying drawings of which:

FIG. 1 is an exploded perspective view of a mobile device in accordance with an embodiment of the present inventive concept;

FIG. 2 is a detailed block diagram of the mobile device of FIG. 1 in accordance with an embodiment of the present inventive concept;

FIG. 3A illustrates a detailed view of the touch sensor panel (TSP) of FIG. 1 in accordance with an embodiment of the present inventive concept;

FIG. 3B illustrates two-dimensional (2D) data obtained by transforming capacitance levels at nodes in the TSP of FIG. 3A;

FIG. 4A illustrates an operation of touching a TSP using a conductor when a density of nodes in the TSP is relatively low;

FIG. 4B illustrates 2D data obtained by transforming capacitance levels at the nodes in the TSP of FIG. 4A;

FIG. 5A illustrates an operation of touching a TSP using a conductor when a density of nodes in the TSP is high;

FIG. 5B illustrates 2D data obtained by transforming capacitance levels at the nodes of the TSP illustrated in FIG. 5A;

FIG. 6A is a graph illustrating a differential capacitance level varying according to locations on a TSP when a touch is input;

FIG. 6B is a table converted from the graph of FIG. 6A;

FIG. 6C illustrates a result of substituting the table of FIG. 6B into Equation 2;

FIGS. 7A and 7B illustrate changes of touch signals according to sizes of conductors;

FIG. 8A is a 2D table showing intensity distribution of a touch signal when a first conductor CP1 illustrated in FIG. 7A is used;

FIG. 8B is a three-dimensional (3D) graph illustrating the 2D table of FIG. 8A;

FIG. 9A is a 2D table showing intensity distribution of a touch signal when a relatively larger conductor illustrated in FIG. 7B is used for a touch;

FIG. 9B is a 3D graph illustrating the 2D table of FIG. 9A;

FIGS. 10A to 10D are 3D graphs each showing a differential capacitance level according to a size of a conductor;

FIG. 11A is a diagram illustrating a distribution of capacitance levels with respect to a transmitting (TX) line when a conductor touches a first point;

FIG. 11B is a graph corresponding to the 2D table of FIG. 11A;

FIG. 12A is a diagram illustrating a distribution of capacitance levels with respect to a TX line when a conductor touches a second point;

FIG. 12B is a graph corresponding to the 2D table of FIG. 12A;

FIG. 13 is a diagram illustrating a characterization method performed by the TSC illustrated in FIG. 2 in accordance with an embodiment of the present inventive concept;

FIGS. 14A to 14D are 2D graphs illustrating differential capacitance levels when a conductor is located on series 1, series 4, series 7, and series 10 in FIG. 13, respectively;

FIG. 15 is a 3D graph illustrating a differential capacitance level according to the location of the conductor of FIG. 13;

FIG. 16 is a table illustrating characterization parameters extracted using the characterization method illustrated in FIGS. 13 to 15 in accordance with an embodiment of the present inventive concept;

FIG. 17A is a 2D graph of touch data collected when first to fourth conductors are used;

FIG. 17B is a graph illustrating a normalized distribution curve generated using the touch data collected when the first to fourth conductors of FIG. 17A are used;

FIG. 18A is a graph illustrating a Lanzcos curve according to Equation 3;

FIG. 18B is a table converted from the Lanzcos curve of FIG. 18A;

FIG. 19A is a graph illustrating a differential capacitance level according to a location of a conductor before an interpolation algorithm is applied;

FIG. 19B is a graph illustrating a differential capacitance level according to a location of a conductor after the interpolation algorithm is applied;

FIG. 20 is a flowchart illustrating a method for driving a TSC in accordance with an embodiment of the present inventive concept;

FIG. 21 is a graph illustrating touch data containing noise and a graph illustrating a result of applying a Lanzcos curve to the touch data;

FIG. 22 is a diagram illustrating a method for generating correct coordinates of a touch input when the touch is input at an edge of the TSP of FIG. 2 in accordance with an embodiment of the present inventive concept;

FIG. 23 is a graph illustrating a differential capacitance level according to a size of a conductor in accordance with an embodiment of the present inventive concept;

FIGS. 24A and 24B are diagrams illustrating a method for driving a TSC in accordance with an embodiment of the present inventive concept;

FIG. 25 is a flowchart illustrating a method for driving a TSC in accordance with an embodiment of the present inventive concept;

FIG. 26 is a diagram illustrating the method for driving the TSC illustrated in FIG. 25;

FIG. 27 is a flowchart illustrating a method for driving a TSC in accordance with an embodiment of the present inventive concept;

FIG. 28 is a block diagram of a computer system that includes the TSC illustrated in FIG. 1 in accordance with an embodiment of the present inventive concept;

FIG. 29 is a block diagram of a computer system that includes the TSC illustrated in FIG. 1 in accordance with an embodiment of the present inventive concept; and

FIG. 30 is a block diagram of a computer system that includes the TSC illustrated in FIG. 1 in accordance with an embodiment of the present inventive concept.

### DETAILED DESCRIPTION OF THE EMBODIMENTS

Embodiments of the present inventive concept will be described in detail with reference to the accompanying drawings. The present inventive concept, however, may be embodied in various different forms, and should not be construed as being limited to the embodiments set forth herein.

Unless otherwise noted, like reference numerals or characters may refer to the same elements throughout the attached drawings and written description. In the drawings, the sizes and relative sizes of layers and regions may be exaggerated for clarity.

As used herein, singular forms are intended to include plural forms as well, unless the context clearly indicates otherwise.

Hereinafter, exemplary embodiments of the present inventive concept will be described with reference to the accompanying drawings.

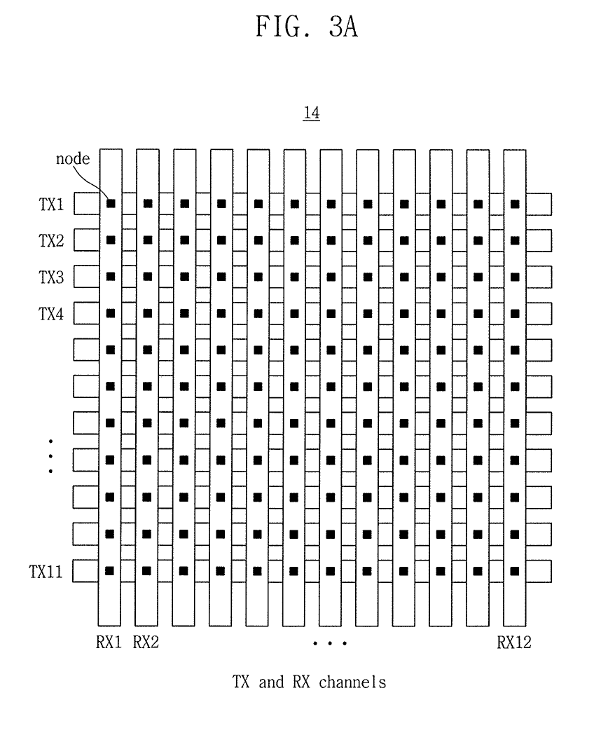

A touch sensor controller (TSC) in accordance with an embodiment of the present inventive concept performs an interpolation algorithm using characterization parameters. Thus, the TSC may extract correct coordinates of a touch input. The TSC in accordance with an embodiment of the present inventive concept will be described with reference to FIGS. 3A to 21.

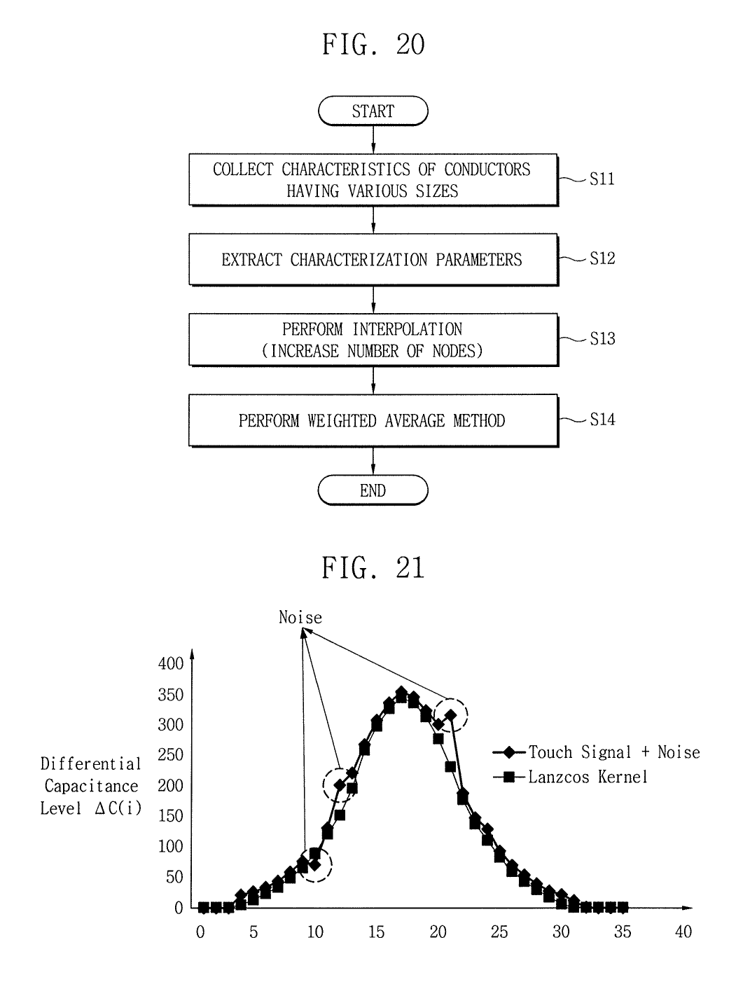

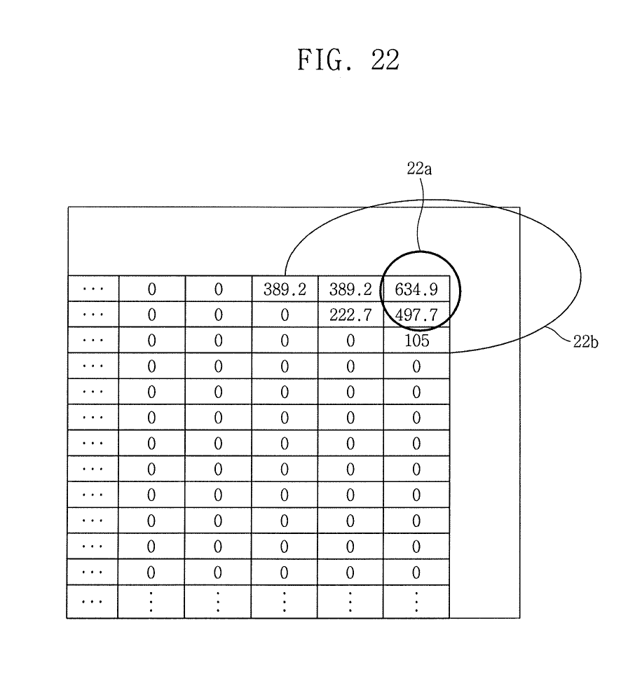

According to an embodiment of the present inventive concept, when an edge of a touch sensor panel (TSP) is touched, a TSC may derive data corresponding to outside of the edge of the TSP from touch data using a Gaussian function to calculate correct coordinates of the touch input at the edge. The touch data may be generated from transmitting (TX)/receiving (RX) electrodes included in the TSP. For example, the TSC may calculate correct coordinates of a touch input at the edge of the TSP based on the derived data. The TSC in accordance with an embodiment of the present inventive concept will be described in detail with reference to FIGS. 22 and 23.

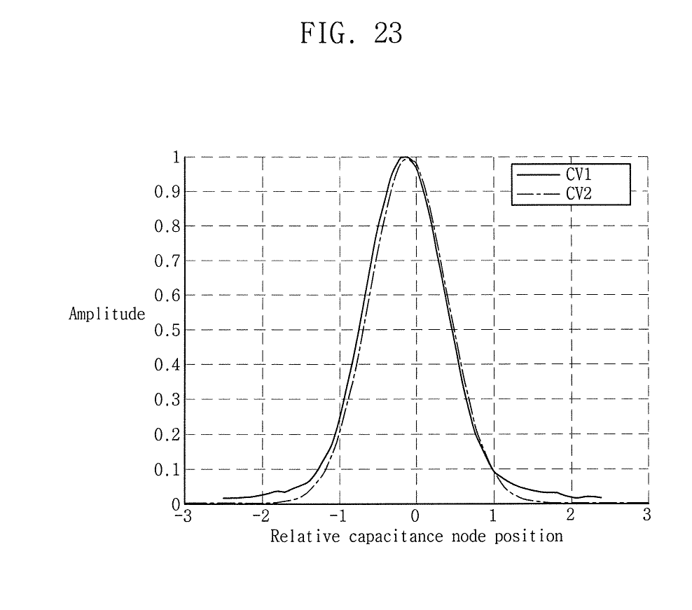

A TSC in accordance with an embodiment of the present inventive concept may reduce an amount of calculation of the interpolation algorithm based on gradients of variations of touch data (e.g., capacitance level) calculated between nodes. The TSC in accordance with an embodiment of the present inventive concept will be described in detail with reference to FIGS. 24 to 27.

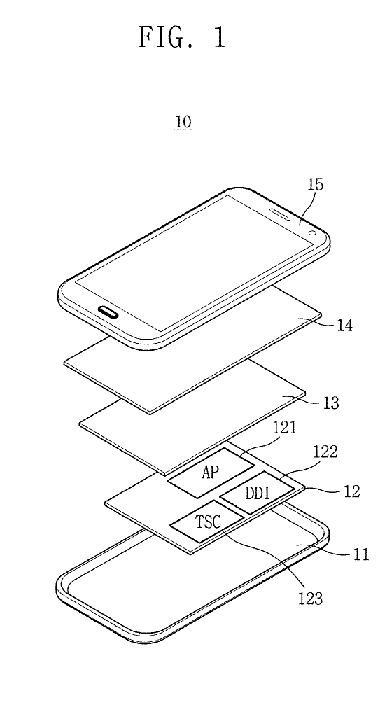

FIG. 1 is an exploded perspective view of a mobile device 10 in accordance with an embodiment of the present inventive concept;

Referring to FIG. 1, the mobile device 10 may include a housing 11, a printed circuit board (PCB) 12, a display module (DM) 13, a TSP 14, and a window cover glass 15.

A smart-phone is illustrated as an example of the mobile device 10. However, the mobile device 10 in accordance with an embodiment of the present inventive concept is not limited to the smart-phone and may be a device such as a navigation device, a computer monitor, a tablet personal computer (PC), or the like.

The housing 11 may accommodate internal components of the mobile device 10 (e.g., the PCB 12, the DM 13, the TSP 14, etc). Although FIG. 1 illustrates that the housing 11 is formed of one component as an example, but the housing 11 may be formed by combining at least two components. Hereinafter, the housing 11 consisting of one component will be described with reference to FIG. 1 as an example. In an embodiment of the present inventive concept, the housing 11 may further accommodate a power source unit (not shown) such as a battery according to a type of a display panel.

The PCB 12 may include an application processor (AP) 121 that processes multimedia data (e.g., a photo or an image) using an application program, a display driver integrated circuit (DDI) 122 that drives the DM 13, and a TSC 123 that controls the TSP 14.

The DM 13 may display an image. However, the type of the DM 13 is not particularly limited and may be one of various display panels, e.g., an organic light-emitting display panel, a liquid crystal display panel, a plasma display panel, an electrophoretic display panel, an electro-wetting display panel, etc.

The TSP 14 is an input unit for the DM 13 and may receive a touch signal. In an embodiment of the present inventive concept, the TSP 14 may be embodied as an electrostatic capacitance touch panel.

The window cover glass 15 is disposed on the TSP 14, and is combined with the housing 11 to form an external surface of the mobile device 10 together with the housing 11.

Although not shown in FIG. 1, the mobile device 10 may further include various other components such as a wireless communication unit that establishes wireless communication, a memory unit (e.g., volatile memory/non-volatile memory) that stores data, a microphone, a speaker, an audio processor, or the like.

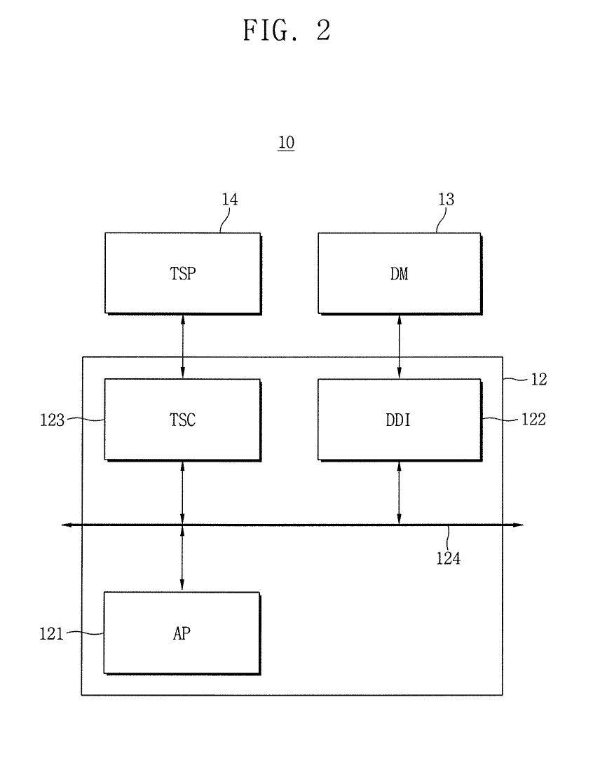

FIG. 2 is a detailed block diagram of the mobile device 10 of FIG. 1 in accordance with an embodiment of the present inventive concept.

Referring to FIGS. 1 and 2, the AP 121, the DDI 122, the TSC 123, and system bus 124 may be mounted on the PCB 12. The DDI 122 may control the DM 13 embodied as a liquid crystal display (LCD), an active matrix light-emitting diode (AMOLED), or the like. The TSC 123 may control the TSP 14. The system bus 124 may connect the AP 121, the DDI 122, and the TSC 123.

The TSP 14 is installed on a front surface of the mobile device 10 and may receive a touch signal from a user. The TSC 123 may transmit the touch signal received from the TSP 14 to the AP 121 or the DDI 122 via the system bus 124.

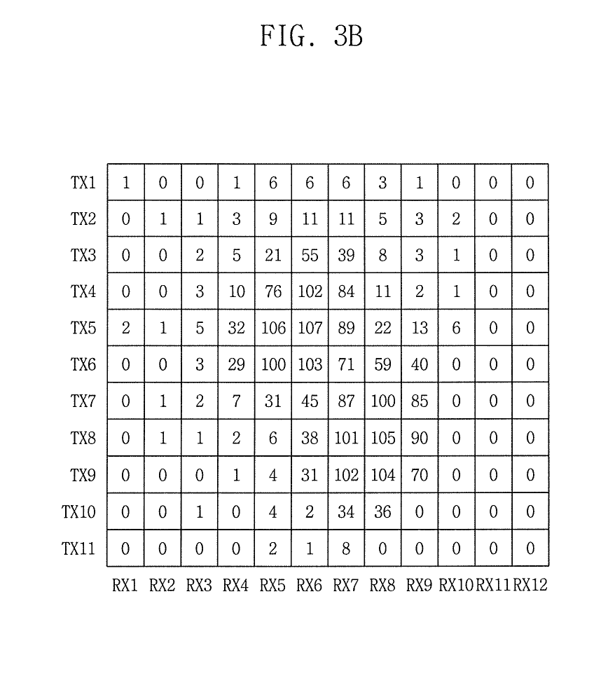

In the TSP 14, metal electrodes are stacked and distributed. Thus, when a user touches the TSP 14, a capacitance level between the metal electrodes in the TSP 14 may change. The TSP 14 transmits the changed capacitance level to the TSC 123. The TSP 14 in accordance with an embodiment of the present inventive concept will be described in detail with reference to FIGS. 3A to 4B.

The TSC 123 may transform the changed capacitance level into X and Y axes coordinates and transmit the X and Y axes coordinates to the AP 121 or the DDI 122 via the system bus 124.

Although not shown, the TSC 123 may include a processor that transforms the changed capacitance level into the X and Y axes coordinates, and a non-volatile memory device that stores a firmware for storing an interpolation algorithm that mathematically increases the number of physically fixed nodes. In an embodiment of the present inventive concept, the non-volatile memory device may include a flash memory device.

The system bus 124 connects the AP 121, the DDI 122, and the TSC 123 to transmit data or a control signal among the AP 121, the DDI 122, and the TSC 123. In an embodiment of the present inventive concept, the system bus 124 may be an inter-integrated circuit (I²C) bus, a serial peripheral interface (SPI) bus, or the like, which is used to establish communication between chips.

The AP 121 may control the DDI 122 or the TSC 123 via the system bus 124. The AP 121 may be a microprocessor designed for use in mobile devices.

In a touch-based interface device, a precision of extracted coordinates may be a factor in determining a performance of the mobile device 10. Thus, the mobile device 10 uses a method for extracting correct coordinates of a touch input. To this end, the TSC 123 in accordance with an embodiment of the present inventive concept may mathematically increase the number of physical nodes by using the interpolation algorithm. Each of the physical nodes is formed where a TX electrode and an RX electrode on the TSP 14 intersect. Thus, the TSC 123 may increase the precision of extracted coordinates of a touch input and the performance of the mobile device 10.

FIG. 3A illustrates a detailed view of the TSP 14 of FIG. 1 in accordance with an embodiment of the present inventive concept.

Referring to FIGS. 2 and 3A, the TSP 14 in accordance with an embodiment of the present inventive concept may include a plurality of TX and RX electrodes (e.g., several tens or several hundreds of TX electrodes arranged in a horizontal line and several tens or several hundreds of RX electrodes arranged in a vertical line). In an embodiment of the present inventive concept, the TSP 14 includes eleven TX electrodes and twelve RX electrodes.

The TX electrodes are electrically insulated from the RX electrodes and arranged to intersect the RX electrodes. Points at which the TX electrodes and the RX electrodes intersect are defined as nodes. When a user touches the TSP 14, capacitance levels at the nodes between the TX electrodes and the RX electrodes may change.

FIG. 3B illustrates two-dimensional (2D) data obtained by transforming capacitance levels at the nodes in the TSP 14 of FIG. 3A.

Referring to FIGS. 2 to 3B, the TSP 14 may measure a variation in capacitance level (e.g., mutual capacitance) generated when a conductor, such as a finger, a stylus pen, or the like, contacts the nodes. Hereinafter, the variation in capacitance level is referred to as a “differential capacitance level”. The TSP 14 may measure the variation in the capacitance level in a form of 2D data. The TSP 14 transmits the 2D data to the TSC 123. Each of the nodes in the TSP 14 corresponds to each 2D touch data point. Although in FIGS. 2 to 3B, it is illustrated that the TSP 14 may measure a differential capacitance level generated when the conductor contacts the nodes, the present inventive concept is not limited thereto. For example, the TSP 14 may measure an absolute capacitance level generated when the conductor contacts the nodes.

Equation 1 below represents a Centroid method which is a method for extracting coordinates. In the Centroid method, the coordinates are extracted using a weighted average method.

In Equation 1, pᵢ denotes physical coordinates of an electrode (e.g., TX or RX electrodes in the TSP 14), and cᵢ denotes a differential capacitance level generated in response to a touch input sensed in the electrode. In addition, N denotes the number of touch electrodes, e.g., the number of TX or RX electrodes. For example, the X or Y axis coordinate is determined by a relative ratio of the differential capacitance level cᵢ.

The 2D data including the differential capacitance level may be transformed into X and Y axes coordinates using Equation 1 below.

$$X = {\sum }_{i}^{{N}^{( x )}} {p}_{i}^{( x )} \cdot {c}_{i}^{( x )} / {\sum }_{i}^{{N}^{( x )}} {c}_{i}^{( x )} \\ Y = {\sum }_{i}^{{N}^{( y )}} {p}_{i}^{( y )} \cdot {c}_{i}^{( y )} / {\sum }_{i}^{{N}^{( y )}} {c}_{i}^{( y )} \qquad [ Equation 1 ]$$

FIG. 4A illustrates an operation of touching a TSP using a conductor when a density of nodes in the TSP is relatively low.

FIG. 4B illustrates 2D data obtained by transforming capacitance levels at the nodes in the TSP of FIG. 4A.

Referring to FIG. 4A, a precision of an algorithm for extracting coordinates may depend on a density of the nodes in the TSP 14. For example, the greater a pitch size between the nodes, the less 2D data that may be obtained using same-sized conductors (e.g., conductive pillars). Thus, an effect of noise corresponding to 2D data may be greater as a pitch size between the nodes is greater. For example, the precision of extracted coordinates may be lowered even though an amount of noise (e.g., an intensity of noise) corresponding to 2D data is low. For example, a relatively small number of TX/RX electrodes may be included in low-priced mobile devices.

Referring to FIGS. 4A and 4B, when the density of the nodes in the TSP 14 is relatively low, a capacitance level at a node that is directly contacted by the conductor may be high (e.g., 800 in FIG. 4B).

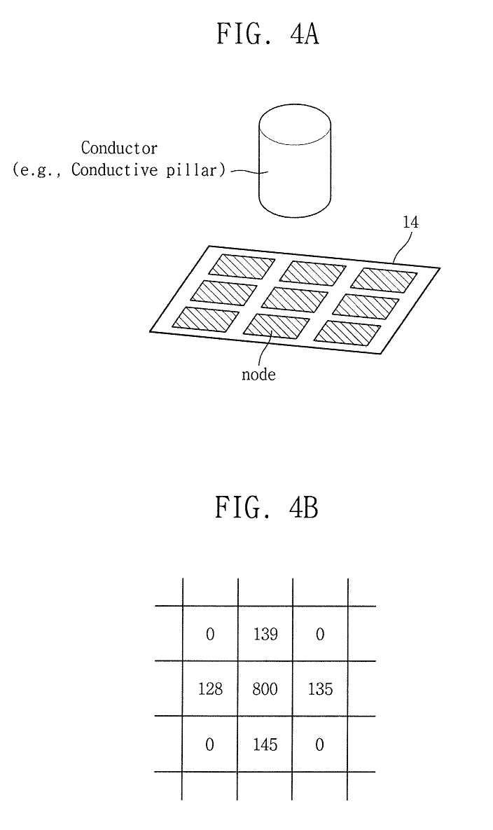

FIG. 5A illustrates an operation of touching a TSP 14 using a conductor when a density of nodes in a TSP is relatively high.

FIG. 5B illustrates 2D data obtained by transforming capacitance levels at the nodes of the TSP 14 of FIG. 5A.

Referring to FIGS. 5A and 5B, when the density of the nodes in the TSP 14 is relatively high, the conductor may contact a greater number of nodes than that of the TSP 14 of FIG. 4A, and thus, a capacitance level may be dispersed over the increased number of plurality of nodes that the conductor contacts. Thus, differential capacitance level at the nodes of the TSP 14 of FIG. 5A may be relatively low.

For example, when the 2D data of FIG. 5B is compared with the 2D data of FIG. 4B, the data corresponding to the center of a node contacted by the conductor has a larger value than that in FIG. 4B. Thus, when the density of the nodes in the TSP 14 is low, the accuracy of coordinates may be more influenced by noise than when the density of nodes in the TSP 14 is high.

Equation 2 below represents a weighted average method (e.g., the Centroid method) that may be used regardless of the X-axis and the Y-axis, compared to Equation 1. The Centroid method may be used to extract coordinates and is simple since it needs a low amount of calculation. However, the Centroid method is vulnerable to noise generated in each of regions since weights are assigned to locations during the calculation.

$$\frac{{\sum }_{i = 0}^{i = N} i \cdot C ( i )}{{\sum }_{i = 0}^{i = t} C ( i )} = {i}_{result} \\ N = the number of data points \qquad [ Equation 2 ]$$

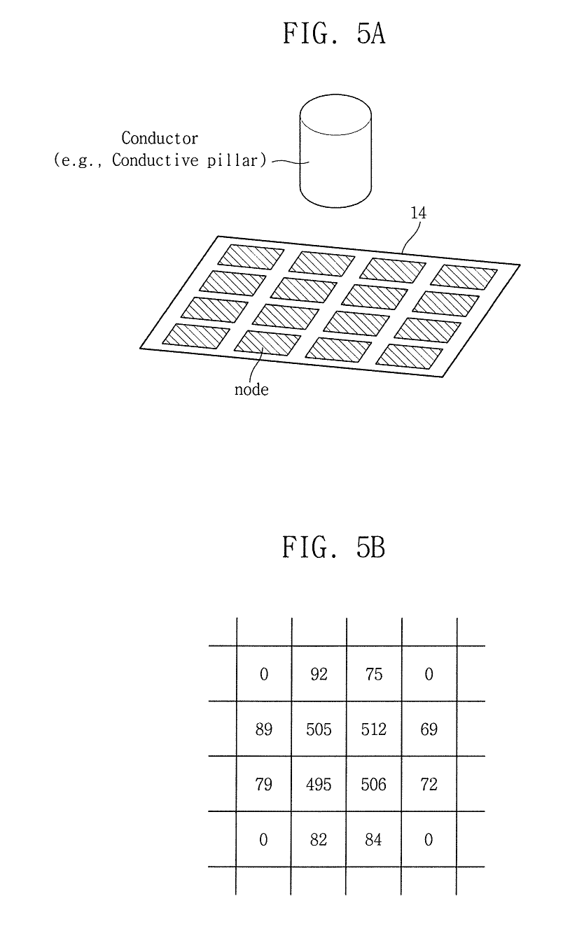

The Centroid method of extracting coordinates, which is expressed in Equation 2, will be described in detail with reference to FIGS. 6A to 6C.

FIG. 6A is a graph illustrating a differential capacitance level ΔC(i) according to locations on a TSP when a touch is input.

FIG. 6A is a graph illustrating a differential capacitance level ΔC(i) generated in response to a touch input. Referring to FIG. 6A, a horizontal axis (e.g., X-axis) denotes a location i of a touch input, and a vertical axis (e.g., Y-axis) denotes a differential capacitance level ΔC(i) corresponding to the location i of the touch input. The actual location i of the touch input is a position at which the differential capacitance level ΔC(i) is maximum.

FIG. 6B is a table converted from the graph of FIG. 6A.

In FIG. 6B, ‘i’ denotes the X or Y-axis coordinate of the touch input on the TSP 14 of FIG. 1, and ‘ΔC(i)’ denotes a differential capacitance level corresponding to the X or Y-axis coordinate i. The X or Y-axis coordinate i may have a maximum value between ‘4’ and ‘5’.

FIG. 6C illustrates a result of substituting the table of FIG. 6B into Equation 2.

Referring to FIGS. 6B and 6C, in a method of extracting coordinates using Equation 2, a numerator (e.g., the sum of the products of the X or Y-axis coordinate i and the differential capacitance levels ΔC(i) corresponding to the X or Y-axis coordinate i) is divided by a denominator (e.g., the sum of the differential capacitance levels ΔC(i) corresponding to the X or Y-axis coordinate i). A result iᵣₑₛᵤₗₜ of dividing the numerator by the denominator is the coordinates of the location corresponding to the X or Y-axis coordinate i. When the table of FIG. 6B is substituted into Equation 2, the result iᵣₑₛᵤₗₜ is about ‘4.5’. For example, the location of the X or Y-axis coordinate i of the touch input is about ‘4.5’.

The precision of the extracted coordinates of the touch input may depend on shapes of electrodes, and alignments between the electrodes, and a size of contact by a conductor.

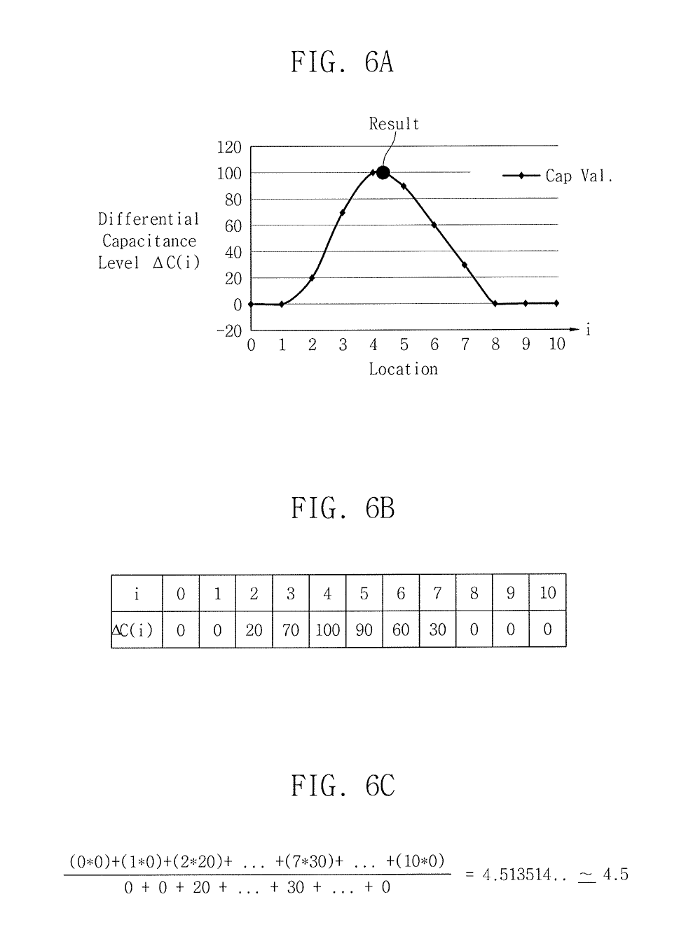

FIGS. 7A and 7B illustrate changes of touch signals according to sizes of conductors.

Referring to FIG. 7A, when a first conductor CP1 having a small size is used, the center of the first conductor CP1 may be biased to a side of the first node ND1. Thus, a differential capacitance level at the first node ND1 might not be sufficiently reflected on 2D sensed data.

In addition, referring to FIG. 7B, when a second conductor CP2 having a larger size than the first conductor CP1 is used, the center of the second conductor CP2 may be biased to a side of a second node ND2. A differential capacitance level at the second node ND2 may be reflected more sufficiently than that of FIG. 7A on the 2D sensed data. For example, the differential capacitance level at the second node ND2 may be sufficiently reflected. For example, when a size of a conductor is smaller than that of when a human touch (e.g., the finger) is performed, the precision of the extracted coordinates may be decreased.

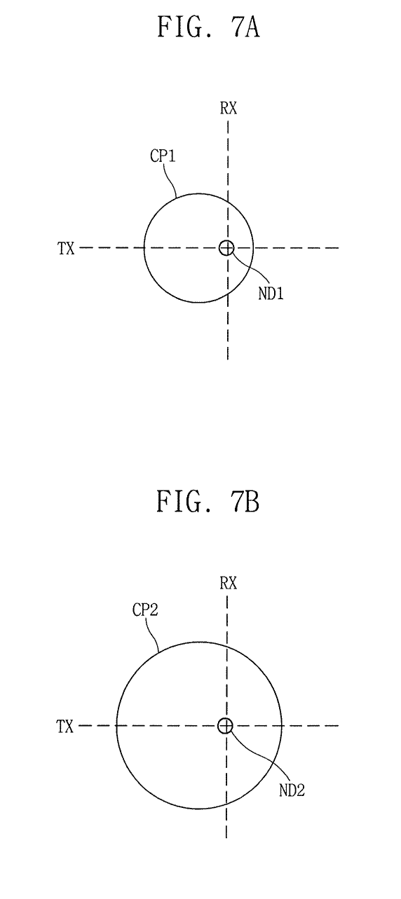

FIG. 8A is a 2D table showing intensity distribution of a touch signal when the first conductor CP1 illustrated in FIG. 7A is used.

FIG. 8B is a three-dimensional (3D) graph illustrating the 2D table of FIG. 8A.

Referring to FIGS. 2, 8A, and 8B, when the size of the first conductor CP1 is small, values of touch data (e.g., the differential capacitance level) are low. In addition, the values of the touch data may be distributed over a narrow range of nodes since the number of nodes influenced by the contact of the first conductor CP1 is low.

When the number of nodes influenced by the contact of the first conductor CP1 is low, an error may increase in a result according to Equation 1 or 2. For example, when the size of the first conductor CP1 is small, the precision of extracted coordinates by the TSC 123 may be reduced even though an intensity of noise is low. For example, if the first conductor CP1 is a stylus pen, it may be difficult for the TSC 123 to precisely transform the touch signal using the stylus pen into corresponding coordinates.

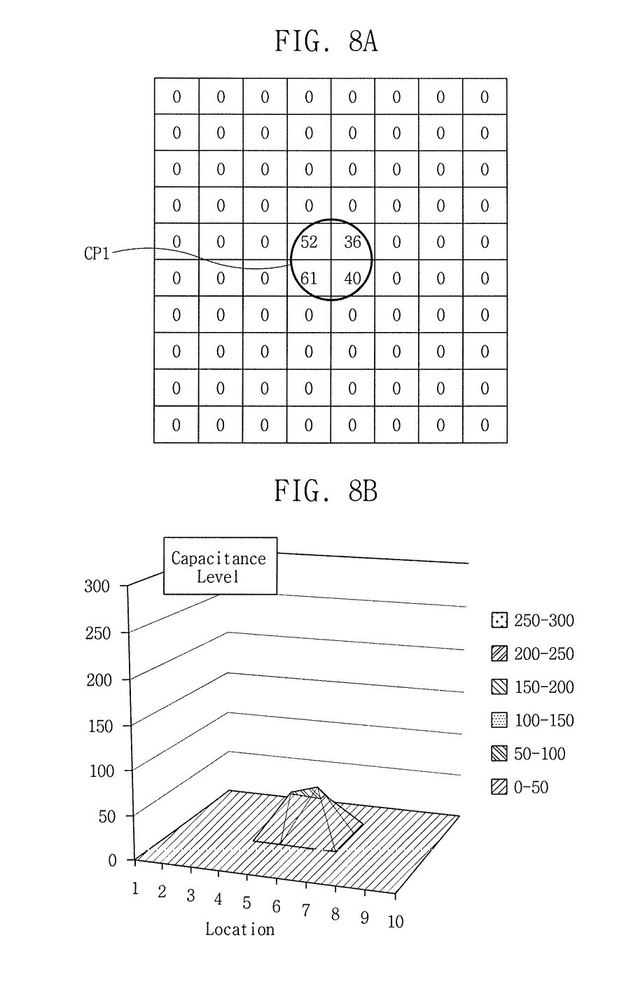

FIG. 9A is a 2D table showing intensity of a touch signal when the second conductor CP2 illustrated in FIG. 7B is used.

FIG. 9B is a 3D graph illustrating the 2D table of FIG. 9A.

Referring to FIGS. 2, 9A, and 9B, when the size of the second conductor CP2 is large, values of the touch data (e.g., the differential capacitance level) are high. In addition, since the number of nodes influenced by the contact of the second conductor CP2 is high, the values of the touch data may be distributed over a broad range of nodes.

When the number of nodes influenced by the second conductor CP2 is large, an error may decrease in a result according to Equation 1 or 2. For example, when the size of the second conductor CP2 is large, the precision of extracted coordinates by the TSC 123 might be maintained by the low-intensity noise. For example, if it is assumed that the second conductor CP2 is a human touch (e.g., the finger), the TSC 123 may precisely transform touch data input by the human touch into corresponding coordinates.

For example, when the human touch is used, the TSC 123 may extract correct coordinates of the human touch. When the conductor (e.g., a stylus pen) having a small size is used, the conductor is vulnerable to noise and thus, it may be difficult for the TSC 123 to precisely extract coordinates of a touch input.

To mathematically increase the number of nodes (e.g., the number of touch data points) to be touched by a conductor, characterization parameters generated using touch data corresponding to the size of the conductor are needed in an off-line state. For example, the TSC 123 may mathematically increase the number of physical nodes by applying the interpolation algorithm using the characterization parameters. Thus, the TSC 123 may extract correct coordinates of a touch input even when the size of the conductor is small.

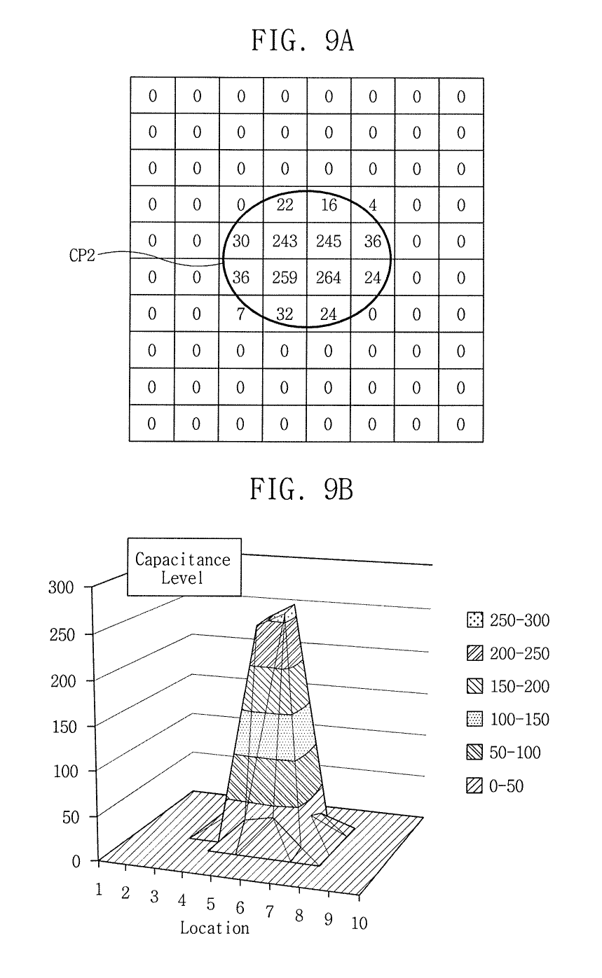

FIGS. 10A to 10D are 3D graphs each showing a differential capacitance level according to a size of a conductor.

Referring to FIGS. 10A to 10D, the larger a diameter of a conductor, the more gentle a gradient of a differential capacitance level. In addition, the larger a pitch size between TX/RX channels of the TSP 14, the more gentle the gradient of the curve of the differential capacitance level.

For example, FIG. 10A is a 3D graph illustrating a differential capacitance level when a diameter of the conductor is 2 phi, and FIG. 10B is a 3D graph illustrating a differential capacitance level when the diameter of the conductor is 4 phi. When the diameter of the conductor is small, the gradient of the curve of the differential capacitance level is steep. Here, 2 phi is equal to 2 mm, and 4 phi is equal to 4 mm. For example, when the diameter of the conductor is 2 phi, the conductor may be a stylus pen.

FIG. 10C is a 3D graph illustrating a differential capacitance level when the diameter of the conductor is 6 phi, and FIG. 10D is a 3D graph illustrating a differential capacitance level when the diameter of the conductor is 8 phi. Here, 6 phi is equal to 6 mm, and 8 phi is equal to 8 mm. For example, when the diameter of the conductor is 8 phi, it may be understood that a human touch (e.g., a touch input made by a finger) is made. The larger the diameter of the conductor, the more gentle the gradient of the curve of the differential capacitance level.

The less the diameter of the conductor, the more the precision of extracted coordinates may be influenced by noise. For example, when the conductor is a stylus pen, the precision of the extracted coordinates may be reduced.

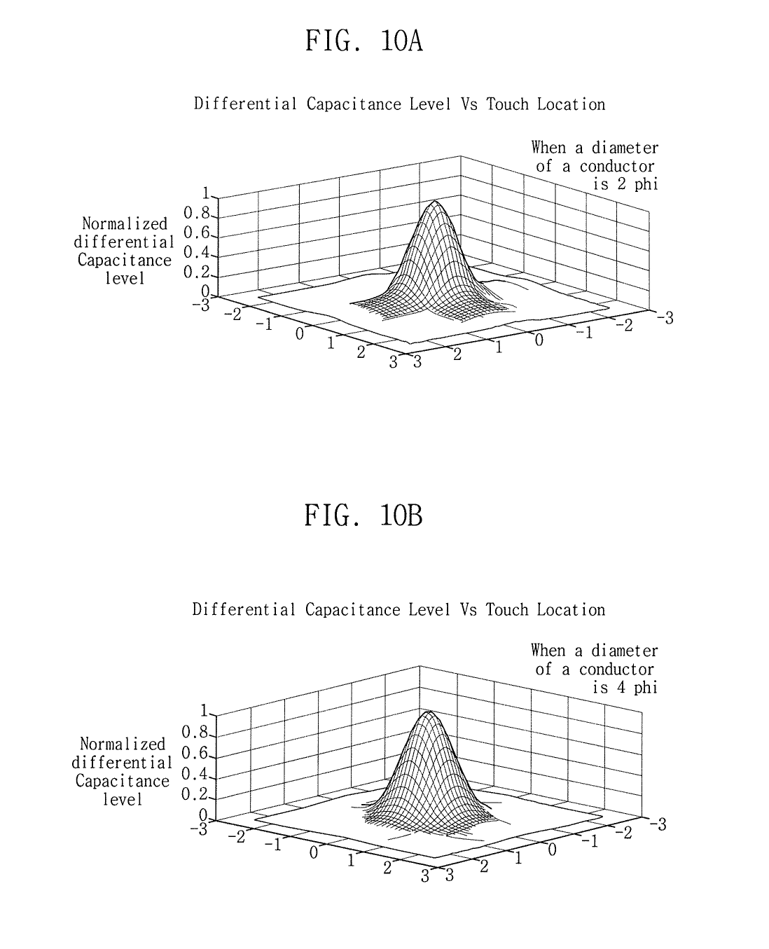

FIG. 11A is a diagram illustrating the distribution of capacitance levels with respect to a transmitting (TX) line when a conductor touches a first point P1. FIG. 11B is a graph corresponding to the 2D table of FIG. 11A.

Referring to FIG. 11A, when the conductor touches the first point P1, differential capacitance levels at nodes in a TX electrode corresponding to the first point P1 increase. The closer nodes in the TX electrode are located to the first point P1, the higher the differential capacitance levels.

Referring to FIG. 11B, in the graph corresponding to the 2D table of FIG. 11A, a capacitance level is maximum at the first point P1 and a curve of the distribution of the capacitance levels has a steep slope.

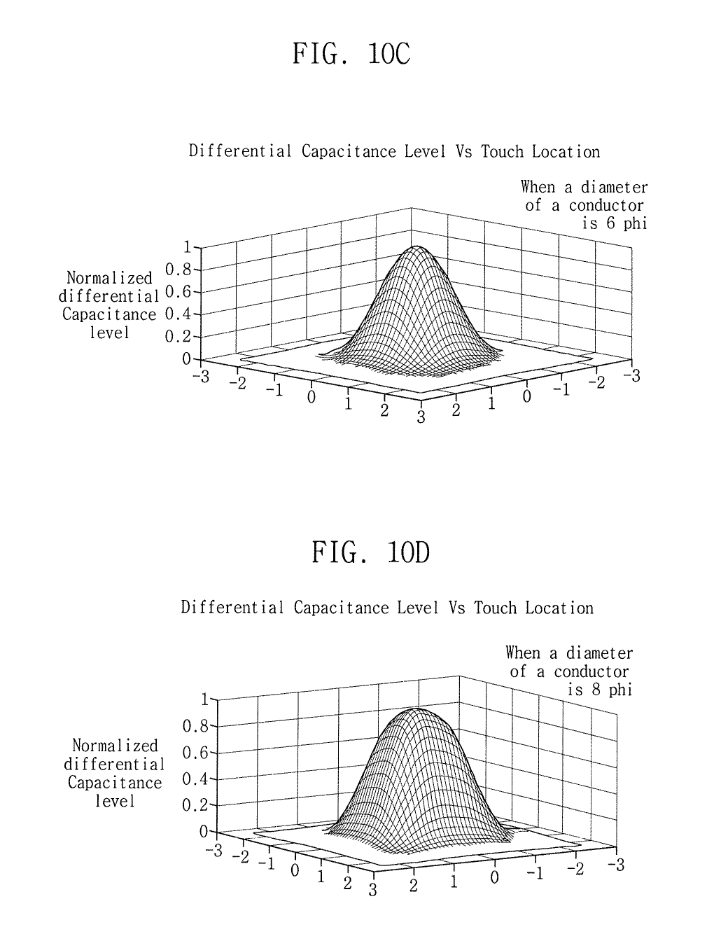

FIG. 12A is a diagram illustrating a distribution of capacitance levels with respect to a TX line when the conductor touches a second point P2. FIG. 12B is a graph corresponding to the 2D table of FIG. 12A.

Referring to FIGS. 12A and 12B, when the conductor touches the second point P2, differential capacitance levels of nodes in a TX electrode corresponding to the second point P2 increase. When the second point P2 is located between nodes, the differential capacitance levels may decrease.

Referring to FIG. 12B, in the graph corresponding to the 2D table of FIG. 12A, a capacitance level is maximum at the second point P2 and a curve of the distribution of the capacitance levels has a gentle slope.

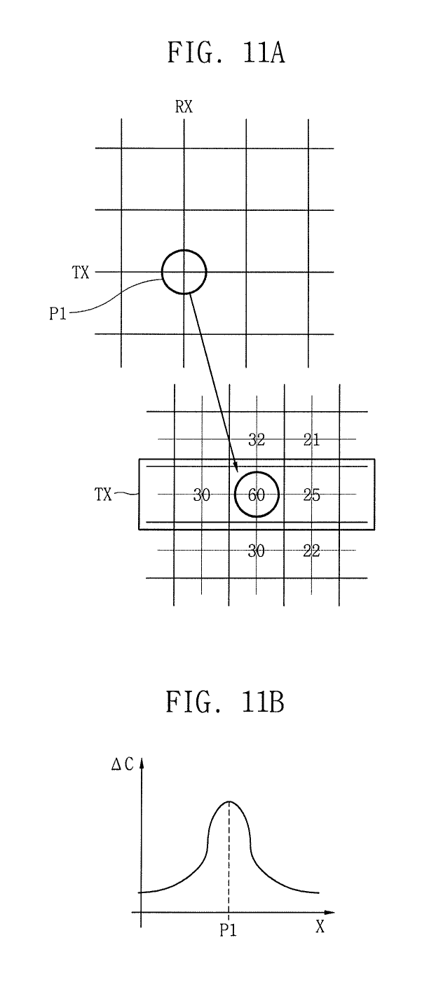

Even if touch data is extracted using a same-sized conductor in the same environment, differential capacitance levels may vary according to the arrangement of TX and RX electrodes and the location of the conductor. In addition, the smaller the size of the conductor, the more remarkable this phenomenon. A characterization method performed by the TSC 123 to compensate for problems caused by the phenomenon will be described with reference to FIGS. 13 to 15.

FIG. 13 is a diagram illustrating the characterization method performed by the TSC 123 illustrated in FIG. 2 in accordance with an embodiment of the present inventive concept.

FIG. 13 illustrates a differential capacitance level in a TX electrode TX_A according to a location of a conductor.

Referring to FIG. 13, the TX electrode TX_A is located on series 4 SR4. The conductor sequentially touches series 1 SR1, series 4 SR4, series 7 SR7, and series 10 SR10.

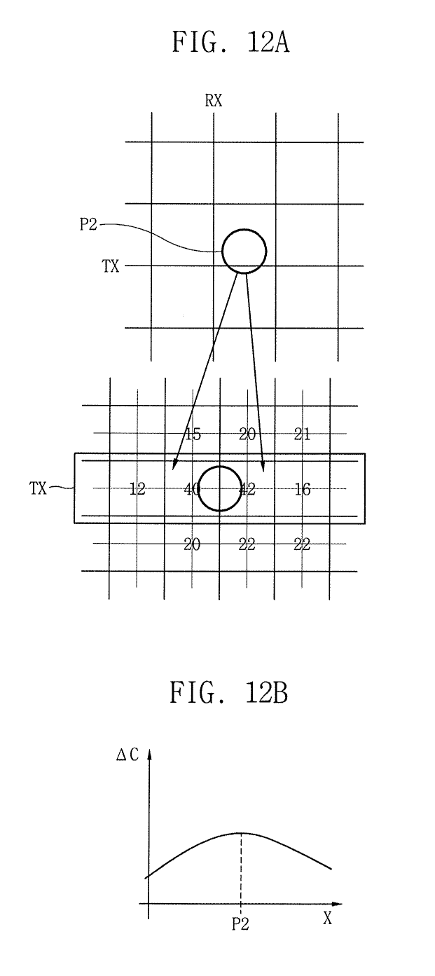

FIGS. 14A to 14D are 2D graphs illustrating differential capacitance levels when a conductor is located on series 1 SR1, series 4 SR4, series 7 SR7, and series 10 SR10 in FIG. 13, respectively.

Referring to FIGS. 13 to 14D, the 2D graph of FIG. 14A illustrates a differential capacitance level when a conductor touches series 1 SR1 with respect to the TX electrode TX_A. The 2D graph of FIG. 14B illustrates a differential capacitance level when the conductor touches series 4 SR4 with respect to the TX electrode TX_A. The 2D graph of FIG. 14C illustrates a differential capacitance level when the conductor touches series 7 SR7 with respect to the TX electrode TX_A. The 2D graph of FIG. 14D illustrates a differential capacitance level when the conductor touches series 10 SR10 with respect to the TX electrode TX_A. The differential capacitance level is maximum at series 4 SR4 on which the TX electrode TX_A is located.

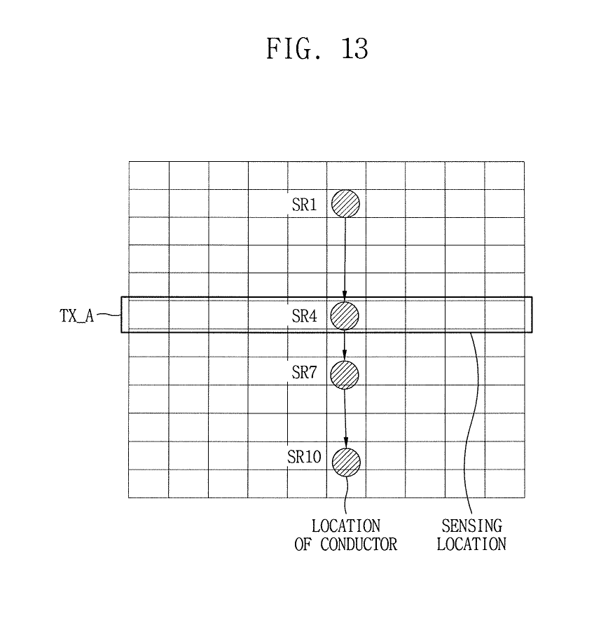

FIG. 15 is a 3D graph illustrating a differential capacitance level according to the location of the conductor of FIG. 13.

Referring to FIGS. 13 to 15, in the graph of FIG. 15, X-axis denotes a location of a conductor in the TX electrode TX_A, Y-axis denotes series1 SR1, series4 SR4, series7 SR7, and series10 SR10, and Z-axis denotes a differential capacitance level. The differential capacitance level is maximum at series4 SR4 on which the TX electrode TX_A is located.

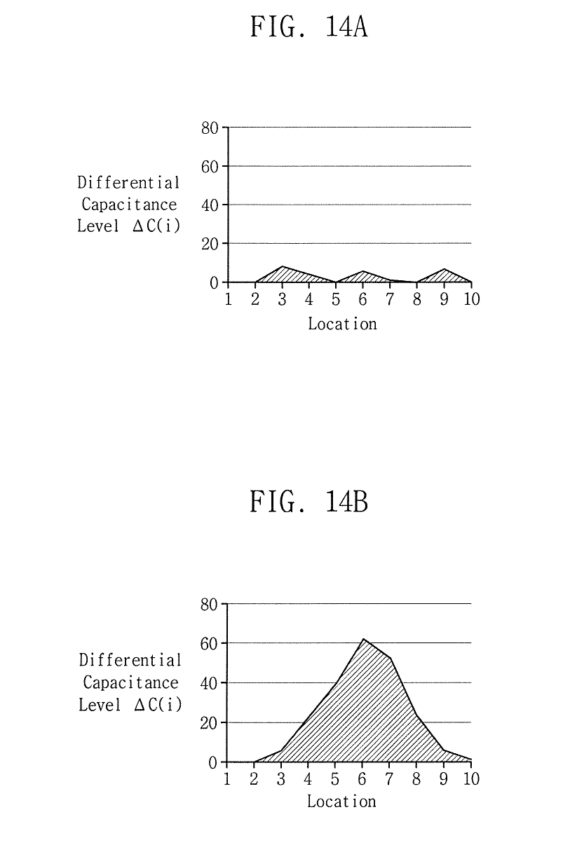

FIG. 16 is a table illustrating characterization parameters extracted using the characterization method illustrated in FIGS. 13 to 15.

Referring to FIG. 16, the characterization parameters may be extracted using a Lanzcos function with respect to touch data corresponding to a size of a conductor.

The characterization parameters may include gradients GradThx and GradThy of a curve according to the size of the conductor, a peak value (e.g., maximum value) according to the size of the conductor, a variance in the Lanzcos curve according to the size of the conductor, and a mean of capacitance levels in a 3×3 region with respect to the peak value according to the size of the conductor.

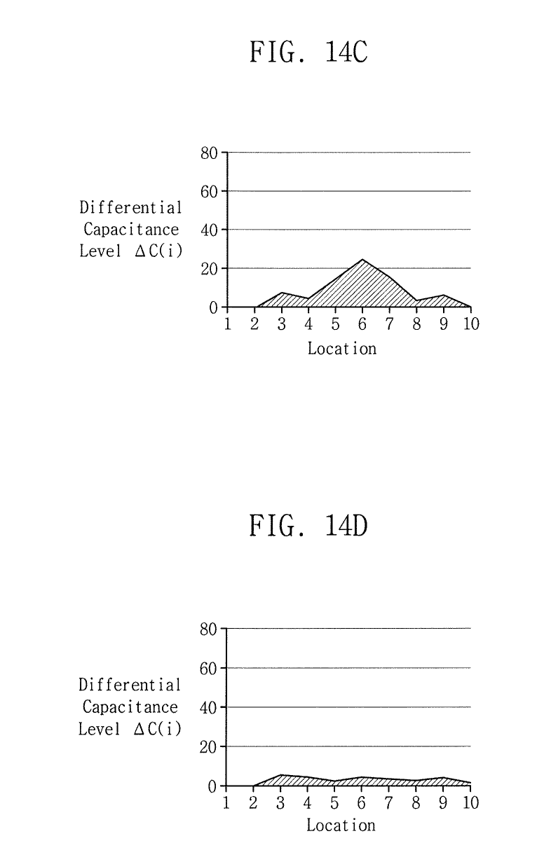

FIG. 17A is a 2D graph of touch data collected when first to fourth conductors CP1 to CP4 are used. For example, sizes of conductors increases from the first to fourth conductors CP1 to CP4.

FIG. 17A illustrates curves corresponding to the cases when the first to fourth conductors CP1 to CP4 are used. The curve corresponding to the first conductor CP1 has the most steep slope and the curve corresponding to the fourth conductor CP4 has the most gentle slope.

FIG. 17B is a graph illustrating a normalized distribution curve generated using the touch data collected when the first to fourth conductors CP1 to CP4 of FIG. 17A are used.

Referring to FIG. 17B, the normalized distribution curve is generated using touch data collected when the first to fourth conductors CP1 to CP4 of FIG. 17A are used. For example, the normalized distribution curve may represent characteristics of the TSP 14 through normalization.

Equation 3 shows a Lanzcos function.

$$L ( x ) = \{ \begin{matrix}sin c ( x ) sin c ( x / a ) & - a < x < a \\ 0 & otherwise\end{matrix} \qquad [ Equation 3 ]$$

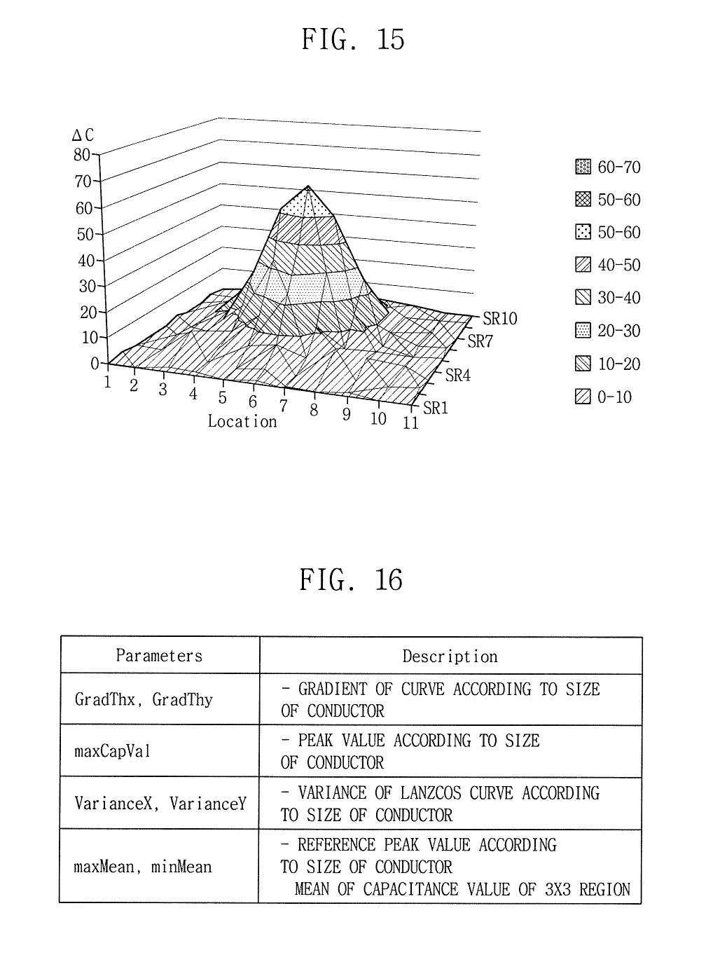

FIG. 18A is a graph illustrating a Lanzcos curve according to Equation 3.

Referring to FIG. 18A, the Lanzcos curve is illustrated when ‘a’ in Equation 3 is set to ‘2’. The Lanzcos curve may have characteristics similar to those of 2D touch data.

FIG. 18B is a table converted from the Lanzcos curve of FIG. 18A.

Referring to FIGS. 18A and 18B, the Lanzcos function may be used to generate filter parameters to which the interpolation algorithm is to be applied. For example, if it is assumed that interpolation is performed for 16 times up-sampling, interpolation in accordance with an embodiment of the present inventive concept is performed by dividing the Lanzcos curve into four sections H1 to H4, dividing each of the four sections H1 to H4 into sixteen phases, and performing up-sampling for the sixteen phases.

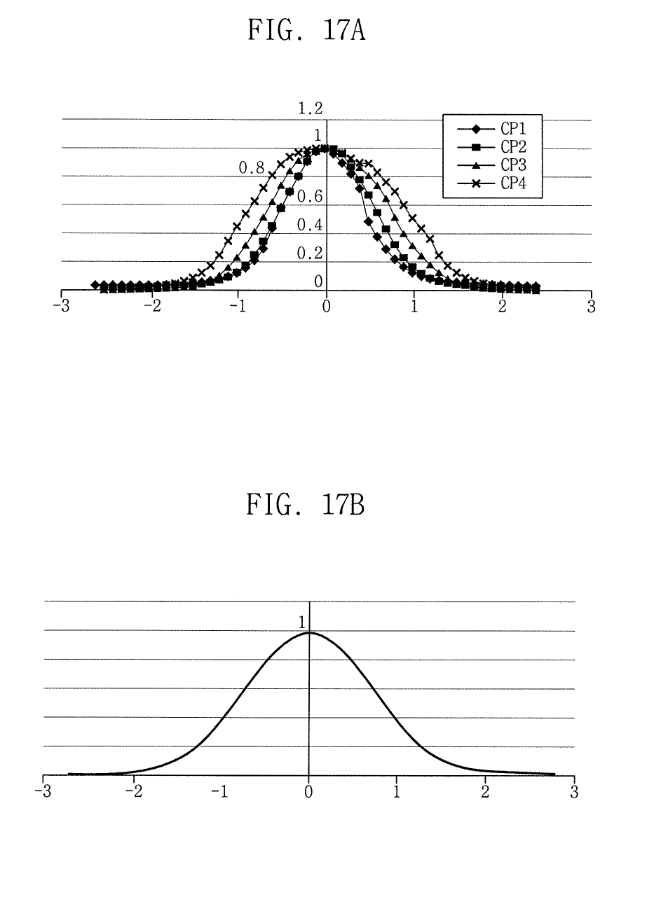

FIG. 19A is a graph illustrating a differential capacitance level according to a location of a conductor before the interpolation algorithm is applied.

FIG. 19A illustrates a 2D graph of a differential capacitance level according to the location of the conductor before the interpolation algorithm is applied, in which the differential capacitance level according to the locations of physical nodes is illustrated.

FIG. 19B is a graph illustrating a differential capacitance level according to the location of the conductor after the interpolation algorithm is applied.

Referring to FIGS. 2, 19A, and 19B, when the interpolation algorithm is applied to the graph of FIG. 19A, nodes that are mathematically calculated are added between the physical nodes.

The TSC 123 in accordance with an embodiment of the present inventive concept may mathematically increase the number of physically fixed nodes using the interpolation algorithm. Thus, the TSC 123 may calculate correct coordinates of a touch input.

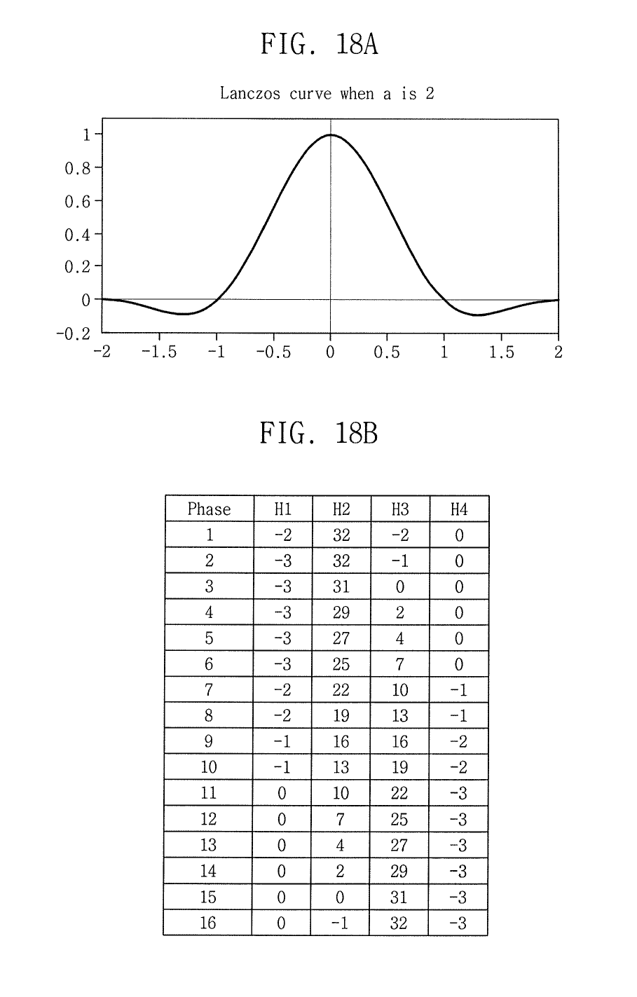

FIG. 20 is a flowchart illustrating a method for driving a TSC in accordance with an embodiment of the present inventive concept.

Referring to FIGS. 2 and 20, in operation S11, a manufacturer of the TSC 123 collects characteristics of conductors having various sizes. For example, the manufacturer may measure differential capacitance levels of conductors having various sizes using the same touch sensor panel in the same environment. As illustrated in FIG. 17B, the manufacturer may generate a normalized distribution curve of the differential capacitance levels according to the locations of the conductors, based on the measured differential capacitance levels.

In operation S12, the manufacturer may extract the characterization parameters of FIG. 16 to perform the interpolation algorithm. The TSC 123 may store the characterization parameters. The characterization parameters may be used as interpolation filter coefficients.

In operation S13, the TSC 123 may perform the interpolation algorithm using the characterization parameters. The number of physically fixed nodes may be mathematically increased using the interpolation algorithm. FIG. 19A illustrates the differential capacitance level according to the location of the conductor before the interpolation algorithm is applied. FIG. 19B illustrates the differential capacitance level according to the location of the conductor after the interpolation algorithm is applied.

In operation S14, the TSC 123 may perform a weighted average method using the mathematically increased nodes. Nodes in the TSP 14 correspond to 2D touch data. For example, the TSC 123 may mathematically increase the physical number of touch data points. The TSC 123 may calculate coordinates using the weighted average method. The TSC 123 may transmit information regarding the calculated coordinates to the AP 121 or the DDI 122.

The TSC 123 in accordance with an embodiment of the present inventive concept applies the weighted average method by mathematically increasing the number of nodes based on the interpolation algorithm. Accordingly, the TSC 123 may extract correct coordinates of a touch input.

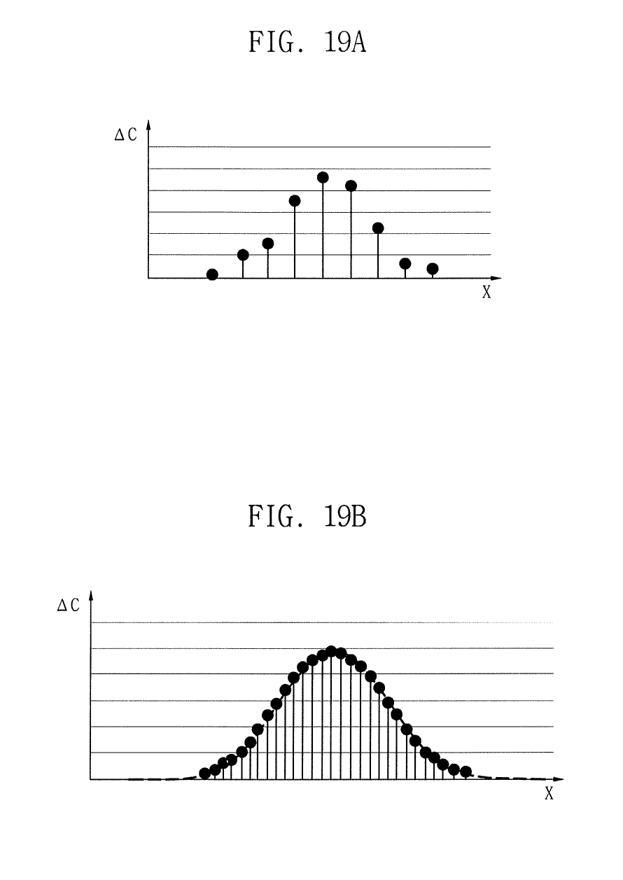

FIG. 21 is a graph illustrating touch data containing noise and a graph illustrating a result of applying a Lanzcos curve to the touch signal.

Referring to FIG. 21, the touch signal may contain noise and thus, precision of extracted coordinates may be influenced by the noise. Thus, the Lanzcos curve may be used to remove the noise contained in the touch signal. For example, when a signal containing such noise is generated, the influence of the noise may be reduced by taking a convolution between the signal and the Lanzcos curve. Thus, the TSC 123 in accordance with an embodiment of the present inventive concept may extract coordinates by reducing the influence of the noise.

In accordance with an embodiment of the present inventive concept, when an edge or a side of the TSP 14 is touched, the TSC 123 may derive data corresponding to outside of the edge or side of the TSP 14 using a Gaussian curve to calculate correct coordinates of a touch input. Thus, the TSC 123 may calculate the correct coordinates of the touch input that is input on the edge or side of the TSP 14.

$$f ( x , y ) = A * {e}^{- ( \frac{{( x - {μ}_{x} )}^{2}}{2 {σ}_{x}^{2}} + \frac{{( y - {μ}_{y} )}^{2}}{2 {σ}_{y}^{2}} )} \qquad [ Equation 4 ]$$

Equation 4 shows the Gaussian curve. Here, ‘A’ denotes a peak value of a pertinent region, ‘μₓ’ denotes a mean of values on the X-axis, ‘μ_{y}’ denotes a mean of values on the Y-axis, ‘ [symbol] ₓ’ denotes a variance of the values on the X-axis, and ‘ [symbol] _{y}’ denotes a variance of the values on the Y-axis.

FIG. 22 is a diagram illustrating a method for generating correct coordinates of a touch input when the touch signal is input at an edge of the TSP 14 in accordance with an embodiment of the present inventive concept.

Referring to FIGS. 2 and 22, when a peak value of the touch signal (e.g., the differential capacitance level) is sensed at an edge or side of TX/RX electrodes, the TSC 123 might not generate correct coordinates of the touch signal. This is because touch data is not collected at the upper, lower, left, and right sides of a touched region when the touched region is located at the edge or side of the TSP 14.

For example, when the peak value of the touch signal (e.g., the differential capacitance level) corresponds to an edge (e.g., 22a) of the TSP 14, data 22b corresponding to an invisible region (e.g., upper or right side of the edge 22a) is not obtained. Thus, when the edge 22a is touched and the TSC 123 might not calculate correct coordinates of touched edge 22a since the data 22b corresponding to the invisible region (e.g., upper or right side of the edge 22a) is not obtained.

Thus, the TSC 123 in accordance with an embodiment of the present inventive concept may derive touch data of the outside, based on touch data corresponding to an inner side of the TSP 14. Thus, the TSC 123 may calculate correct coordinates of a touch input that is input by touching an edge or side of the TSP 14.

In general, the Gaussian curve might not represent differential capacitance curves according to the sizes of conductors. Thus, a variance of the Gaussian curve is determined using characterization parameters corresponding to a size and location of a conductor.

A Gaussian curve fitting method will be described below. The TSC 123 compares means of Gaussian curves with actual touch data while shifting the means and variances of the Gaussian curves. The TSC 123 selects a Gaussian curve having a least difference between the mean thereof with the actual touch data, based on a result of comparing the means of the Gaussian curves with the actual touch data. The TSC 123 may derive touch data of an external region (e.g., outside of the edge of the TSP 14) using the selected Gaussian curve having the least difference between the mean thereof with the actual touch data.

FIG. 23 is a graph illustrating a differential capacitance level according to a size of a conductor in accordance with an embodiment of the present inventive concept.

Referring to FIGS. 2 and 23, a first curve CV1 is a differential capacitance level generated when a conductor having a diameter of 4 phi is used, and a second curve CV2 is obtained by applying the Gaussian curve fitting method to the first curve CV1.

When the interpolation algorithm is performed on the entire region of the TSP 14, an amount of calculation of the TSC 123 may greatly increase. In accordance with an embodiment of the present inventive concept, the TSC 123 selects a first region of the TSP 14 to which the interpolation algorithm is to be applied. The first region may be selected using gradients of differential capacitance levels at nodes around a node having a maximum value. For example, the TSC 123 may perform high-level up-sampling (e.g., mathematically increase the number of nodes) on the selected first region of the TSP 14 that are within a predetermined range in a first direction, and may perform low-level up-sampling on the other regions other than the first region. Here, the first direction is a direction which starts from the node having the maximum value and in which intensity distributions of touch signals are similar (e.g., absolute values of the gradients are small) to each other.

FIGS. 24A and 24B are diagrams illustrating a method for driving a TSC in accordance with an embodiment of the present inventive concept.

Referring to FIG. 24A, the TSP 14 includes first to third nodes N1 to N3. In the TSP 14, a maximum value of differential capacitance level is present between the first node N1 and the second node N2. A differential capacitance level of the first node N1 is ‘C1’. A differential capacitance level of the second node N2 is ‘C2’. A differential capacitance level of the third node N3 is ‘C3’.

The TSC 123 compares a gradient GradXl of a straight line L1 between the differential capacitance level C1 of the first node N1 and the differential capacitance level C2 of the second node N2 with a gradient GradXr of a straight line L2 between the differential capacitance level C2 of the second node N2 and the differential capacitance level C3 of the third node N3. The TSC 123 adds more virtual nodes in a first direction (e.g., between the first node N1 and the second node N2) in which absolute values of the gradients of the differential capacitance levels between nodes are small. In addition, the TSC 123 adds fewer nodes in a direction (e.g., between the second node N2 and the third node N3) other than the first direction.

Referring to FIGS. 2 and 24B, the TSP 14 includes fourth to sixth nodes N4 to N6.

In the TSP 14, a maximum value of differential capacitance level is present between the fifth node N5 and the sixth node N6. A differential capacitance level of the fourth node N4 is ‘C4’. A differential capacitance level of the fifth node N5 is ‘C5’. A differential capacitance level of the sixth node N6 is ‘C6’.

The TSC 123 compares a gradient GradXl of a straight line L3 between the differential capacitance level C4 of the fourth node N4 and the differential capacitance level C5 of the fifth N5 with a gradient GradXr of a straight line L4 between the differential capacitance level C5 of the fifth node N5 and the differential capacitance level C6 of the sixth node N6. The TSC 123 adds more virtual nodes in a first direction (e.g., between the fifth node N5 and the sixth node N6) in which absolute values of the gradients of the differential capacitance levels between nodes are small. In addition, the TSC 123 adds fewer nodes in a direction (e.g., between the fourth node N4 and the fifth node N5) other than the first direction.

If the same interpolation algorithm is applied to the entire region of the TSP 14, an amount of calculation of the TSC 123 may greatly increase. Thus, the TSC 123 in accordance with an embodiment of the present inventive concept may compare gradients of differential capacitance levels between nodes in both directions with respect to a peak point (e.g., the maximum value of differential capacitance level), may perform high-level up-sampling in a direction in which distributions of touch signals are similar to each other (e.g., nodes having a maximum value therebetween), and may perform low-level up-sampling on the other regions (e.g., in a direction other than the direction in which distributions of touch signals are similar to each other).

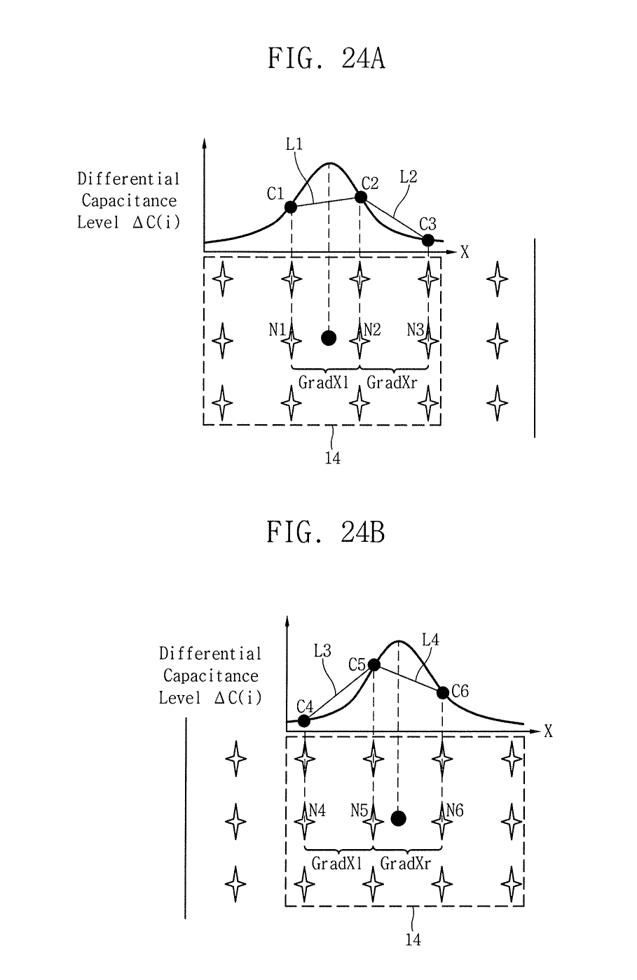

FIG. 25 is a flowchart illustrating a method for driving a TSC in accordance with an embodiment of the present inventive concept.

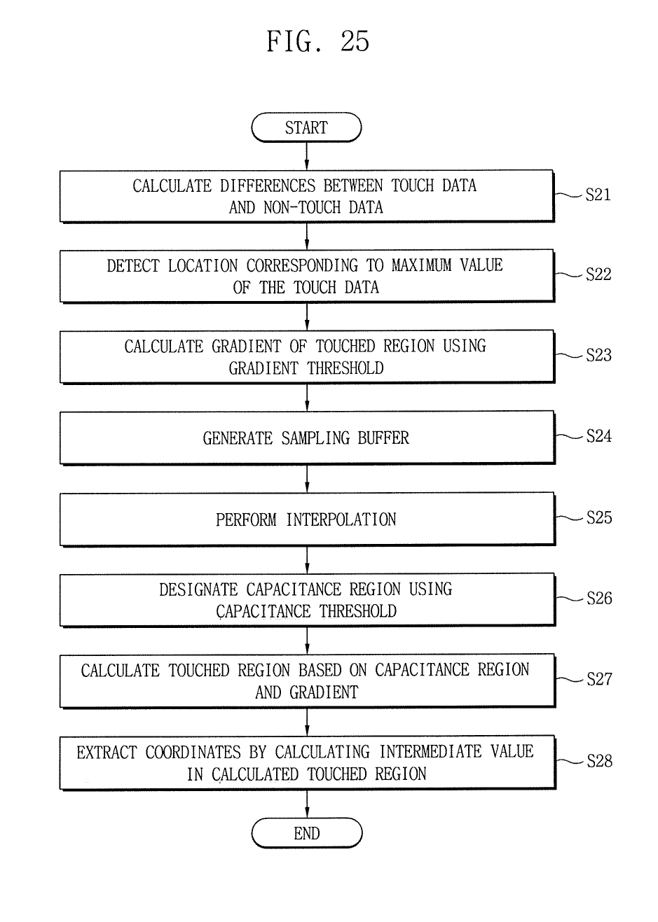

FIG. 26 is a diagram illustrating the method for driving the TSC of FIG. 25.

Referring to FIGS. 2, 25, and 26, in operation S21, the TSC 123 calculates differences between touch data and non-touch data for all nodes.

In operation S22, the TSC 123 detects a location corresponding to a maximum value of the touch data, based on the calculated differences.

In operation S23, the TSC 123 calculates a gradient of a touched region using a gradient threshold. For example, the gradient of the touched region is a gradient of differential capacitance levels in the touched region. For example, the TSC 123 may select a touched region based on the gradient threshold. The TSC 123 calculates gradients in upper, lower, left., and right directions, in the vicinity of the location corresponding to the maximum value.

In operation S24, the TSC 123 generates a sampling buffer. For example, the TSC 123 generates the sampling buffer to store information regarding mathematically increased nodes.

In operation S25, the TSC 123 performs interpolation. The TSC 123 stores in the sampling buffer a result of performing interpolation on the intervals between nodes based on the gradients between the nodes.

In operation S26, the TSC 123 designates a capacitance region using a capacitance threshold. To leave only an effective region R, a touched region having a value that is greater than the capacitive threshold is extracted from entire touch data.

Referring to 2D touch data illustrated in FIG. 26, when the capacitance threshold is set to ‘6’, the TSC 123 may leave only the effective region R having touch data having a value that is equal to or greater than ‘7’ among the 2D touch data.

In operation S27, the TSC 123 calculates the touched region based on the capacitance region and the gradient of the touched region. For example, the TSC 123 calculates the effective region R included in the touched region.

In operation S28, the TSC 123 extracts coordinates by calculating an intermediate value in the calculated touched region. For example, the TSC 123 calculates coordinates by using the Centroid method.

The TSC 123 in accordance with an embodiment of the present inventive concept may recognize a conductor having a diameter that is less than that of a general target human touch using virtual sensing nodes added based on the interpolation algorithm. Thus, a stylus pen or various other input tools may be used. Accordingly, the TSC 123 may recognize a fine touch operation such as hand writing or drawing a picture.

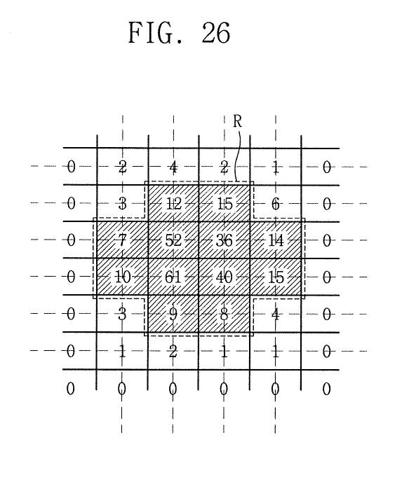

Methods for driving the TSC 123 in accordance with embodiments of the present inventive concept will be described with reference to FIG. 27 below.

FIG. 27 is a flowchart illustrating a method for driving a TSC in accordance with an embodiment of the present inventive concept.

Referring to FIGS. 2 and 27, in operation S31, the TSC 123 receives 2D touch data from the TSP 14.

In operation S32, the TSC 123 determines whether a maximum value of the 2D touch data is present at an edge or side of the TSP 14. Operation S33 is performed when the maximum value of the 2D touch data is present at the edge or side of the TSP 14, and operation S34 is performed when the maximum value of the 2D touch data is not present at the edge or side of the TSP 14.

In operation S33, the TSC 123 performs an extrapolation algorithm on the 2D touch data.

In operation S34, the TSC 123 selects a region of the 2D touch data based on gradients. For example, the TSC 123 calculates the gradients in the vicinity of a maximum value of the 2D touch data. In detail, the TSC 123 compares the maximum value of the touch data with values of data around data having the maximum value.

In operation S35, the TSC 123 performs interpolation algorithm on the 2D touch data.

In operation S36, the TSC 123 applies the Centroid method to the interpolated 2D touch data. Thus, the TSC 123 may extract coordinates corresponding to the 2D touch data.

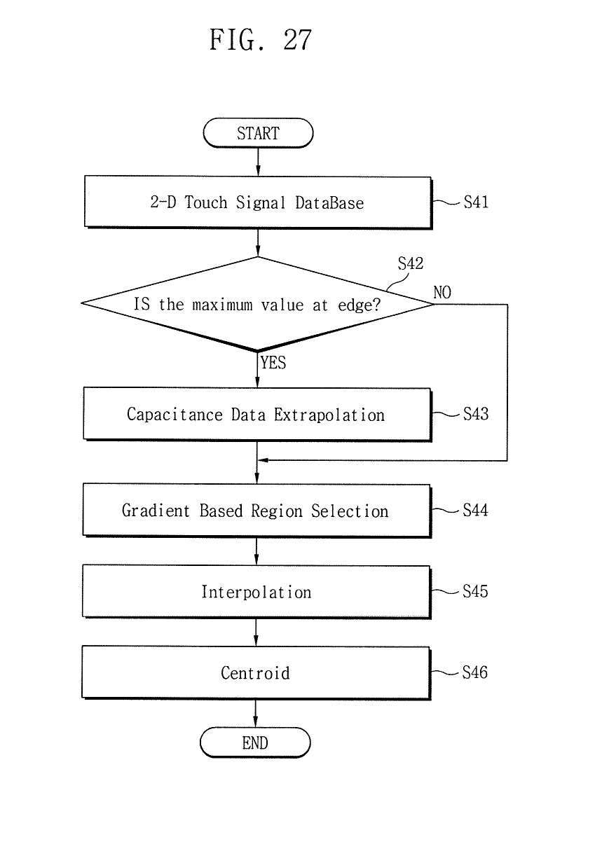

FIG. 28 is a block diagram of a computer system 210 that includes the TSC 123 illustrated in FIG. 1 in accordance with an embodiment of the present inventive concept.

Referring to FIG. 28, the computer system 210 includes a memory device 211, an application processor (AP) 212 including a memory controller for controlling the memory device 211, a radio transceiver 213, an antenna 214, an input device 215, and a display device 216.

The radio transceiver 213 may transmit or receive a radio signal via the antenna 214. For example, the radio transceiver 213 may transform a radio signal received via the antenna 214 into a signal to be processed by the AP 212.

Thus, the AP 212 may process the radio signal output from the radio transceiver 213 and transmit the processed signal to the display device 216. In addition, the radio transceiver 213 may transform a signal output from the AP 212 into a radio signal and transmit the radio signal to an external device via the antenna 214.

The input device 215 is a device via which a control signal for controlling an operation of the AP 212 or data to be processed by the AP 212 is input. For example, the input device 215 may be embodied as a pointing device such as a touch pad, a computer mouse, a keypad, a keyboard, or the like.

In an embodiment of the present inventive concept, the input device 215 may be embodied to include the TSP 14 of FIG. 1 and the TSC 123 configured to control the TSP 14.

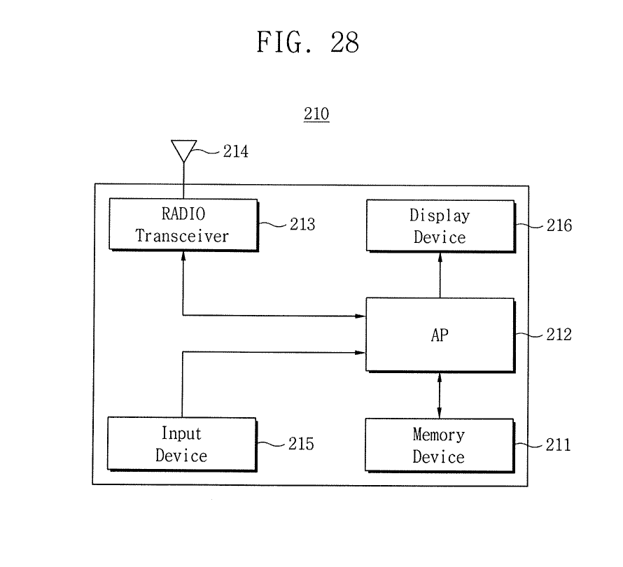

FIG. 29 is a block diagram of a computer system 220 that includes the TSC 123 illustrated in FIG. 1 in accordance with an embodiment of the present inventive concept.

Referring to FIG. 29, the computer system 220 may be embodied as a personal computer (PC), a network server, a tablet PC, a net-book, an e-reader, a personal digital assistant (PDA), a portable multimedia player (PMP), an MP3 player, an MP4 player, or the like.

The computer system 220 includes a memory device 221, an AP 222 including a memory controller configured to control a data processing operation of the memory device 221, an input device 223, and a display device 224.

The AP 222 may display data stored in the memory device 221 on the display device 224 according to data input via the input device 223. For example, the input device 223 may be embodied as a pointing device such as a touch pad, a computer mouse, a keypad, a keyboard, or the like. The AP 222 may control overall operations of the computer system 220 and an operation of the memory device 221.

In an embodiment of the present inventive concept, the input device 223 may be embodied to include the TSP 14 of FIG. 1 and the TSC 123 configured to control the TSP 14.

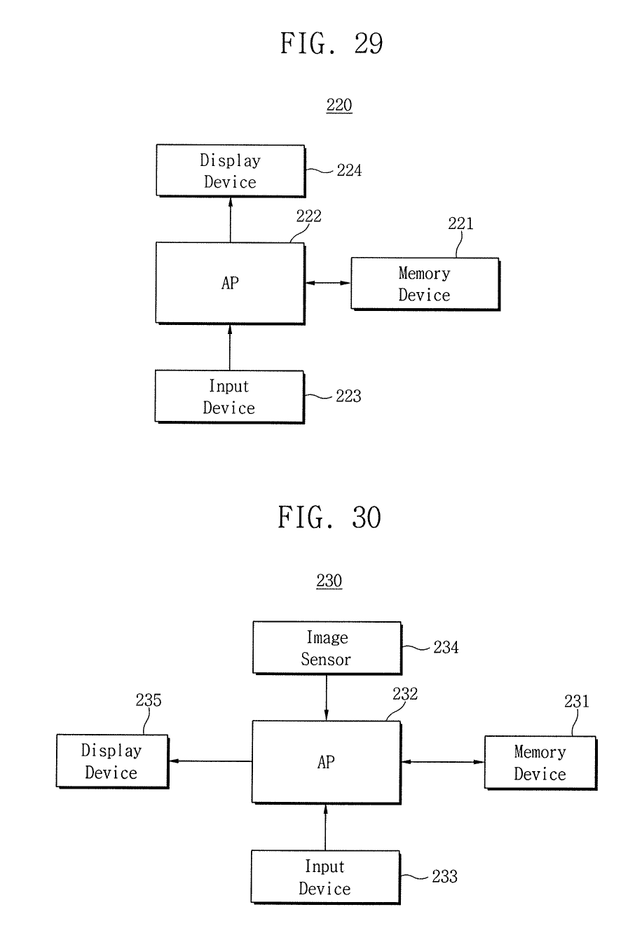

FIG. 30 is a block diagram of a computer system 230 that includes the TSC 123 illustrated in FIG. 1 in accordance with an embodiment of the present inventive concept.

Referring to FIG. 30, the computer system 230 may be embodied as an image process device, e.g., a digital camera, a mobile phone, a smart-phone, a tablet PC with a built-in digital camera, or the like.

The computer system 230 may further include a memory device 231, an AP 232 including a memory controller configured to control a data processing operation (e.g., a write/read operation) of the memory device 231, an input device 233, an image sensor 234, and a display device 235.

The image sensor 234 of the computer system 230 transforms an optical image into digital signals. The digital signals are transmitted to the AP 232. Under control of the AP 232, the digital signals may be displayed on the display device 235 or stored in the memory device 231.

In addition, data stored in the memory device 231 may be displayed on the display device 235 under control of the AP 232.

The input device 233 is a device via which a control signal for controlling an operation of the AP 232 or data to be processed by the AP 232 is input, and may be embodied as a pointing device such as a touch pad, a computer mouse, a keypad, a keyboard, or the like.

In an embodiment of the present inventive concept, the input device 233 may be embodied to include the TSP 14 of FIG. 1 and the TSC 123 configured to control the TSP 14.

A TSC in accordance with an embodiment of the present inventive concept may extract correct coordinates of a touch input.

The foregoing is illustrative of embodiments of the present inventive concept and the present inventive concept should not to be construed as being limited by the embodiments described herein. Although multiple embodiments have been described, it will be understood that various modifications in form and detail may be possible therein without departing from the spirit and scope of the present inventive concept.

What is claimed is:

1. A method for driving a touch sensor controller, comprising:
receiving touch data from a touch sensor panel; and
performing interpolation on the received touch data using characterization parameters according to a size and location of a conductor to increase a number of touch data points.

2. The method of claim 1, wherein the performing of the interpolation comprises using the characterization parameters as interpolation filter coefficients.

3. The method of claim 1, further comprising applying a weighted average method to the increased number of touch data points.

4. The method of claim 3, wherein the applying of the weighted average method comprises calculating coordinates corresponding to a touch input.

5. The method of claim 1, further comprising performing extrapolation on the touch data when a location having a maximum value of the touch data is an edge or side of the touch sensor panel.

6. The method of claim 5, wherein the performing of the extrapolation comprises deriving virtual touch data corresponding to the outside of the touch sensor panel.

7. The method of claim 6, wherein the performing of the extrapolation algorithm comprises using a Gaussian function.

8. The method of claim 1, further comprising:
selecting a first region of the touch sensor panel using a gradient of the touch data in the vicinity of a maximum value among the touch data; and
performing the interpolation on the first region.

9. The method of claim 8, wherein the gradient of the touch data is calculated by comparing differential values between touch data in the vicinity of the maximum value among the touch data.

10. The method of claim 1, wherein the characterization parameters include a gradient of a curve of a differential capacitance level according to the size and location of the conductor, a peak value, and a variance in a Lanzcos curve.

11. A touch sensor controller configured to receive touch data from a touch sensor panel, and to perform interpolation on the received touch data using characterization parameters according to a size and location of a conductor to increase a number of the touch data points.

12. The touch sensor controller of claim 11, wherein the characterization parameters are used as interpolation filter coefficients.

13. The touch sensor controller of claim 11, wherein the characterization parameters comprise a gradient of a curve of a differential capacitance level according to the size and location of the conductor, a peak value, and a variance in a Lanzcos curve.

14. The touch sensor controller of claim 11, wherein the touch sensor controller is configured to perform extrapolation on the touch data when a location having a maximum value of the touch data is an edge or side of the touch sensor panel.

15. The touch sensor controller of claim 11, wherein the touch sensor controller is configured to select a first region of the touch sensor panel using a gradient of the touch data in the vicinity of a maximum value among the touch data, and to perform the interpolation on the first region.

16. A circuit board including the touch sensor controller of claim 11, comprising:
an application processor configured to process multimedia data; and
the touch sensor panel configured to receive the touch data,
wherein the characterization parameters include a gradient of a curve of a differential capacitance level according to the size and location of the conductor, a peak value, and a variance in a Lanzcos curve.

17. A method for driving a touch sensor controller, comprising:
receiving touch data from a touch sensor panel when a touch is input;
detecting a location having a maximum value among the received touch data;
calculating gradients of differential values between touch data in the vicinity of the maximum value; and
performing interpolation on a first region of the received touch data, wherein the first region is selected based on the calculated gradients to increase a number of touch data points.

18. The method of claim 17, wherein the performing of the interpolation comprises using characterization parameters according to a size and location of a conductor as interpolation filter coefficients.

19. The method of claim 17, further comprising:
storing the increased touch data in a sampling buffer as first touch data; and
extracting second touch data from the first touch data using a capacitance threshold, wherein the second touch data is extracted when a value of the second touch data is equal to or greater than the capacitance threshold.

20. The method of claim 17, further comprising:
calculating a touched region based on the second touch data; and
extracting coordinates of the touch input by applying a Centroid method to values corresponding to the calculated touched region.
